(19) United States
(12) Patent Application Publication
(10) Pub. No.: US 2021/0286173 A1
(43) Pub. Date: Sep. 16, 2021

(54) CLEANING BODY AND CLEANING DEVICE

(71) Applicant: Nippon Telegraph and Telephone Corporation, Tokyo (JP)

(72) Inventors: Takafumi FUKATANI, Tokyo (JP); Takeshi SEKI, Tokyo (JP); Yuichiro IKUMA, Tokyo (JP)

(21) Appl. No.: 17/256,929

(22) PCT Filed: Jul. 16, 2019
(86) PCT No.: PCT/JP2019/027965

§ 371 Date: Dec. 29, 2020

(30) Foreign Application Priority Data
Jul. 17, 2018 (JP) 2018-134235

(51) Int. Cl. G02B 27/00; B08B 1/04; B08B 1/00; C03C 25/70

(52) U.S. Cl. CPC G02B 27/0006; B08B 1/04; G02B 6/24; C03C 25/70; B08B 2240/02; B08B 1/006

(57) ABSTRACT

A cleaning body 10 of the present invention includes a cloth-like body unit 11 and a washing liquid enclosure 12 provided on a surface of the body unit 11 or inside the body unit 11 and enclosing a washing liquid including alcohol. This can reduce a burden of conveyance by a user to enhance safety, and suitably exhibit cleaning capability.

### TECHNICAL FIELD

The present invention relates to a cleaning body and a cleaning device.

### BACKGROUND ART

Coupling optical fibers requires cleaning of end surfaces of the optical fibers. Here, when sticking matters adhere to the end surfaces of the optical fibers, only wiping the end surfaces of the optical fibers with a cloth or the like does not provide a sufficient cleaning force.

Patent Literature 1 discloses a device that uses a pair of cleaning tapes to hold an optical fiber therebetween and lets out the cleaning tapes while supplying a washing solvent to thereby clean the optical fiber.

### CITATION LIST

### Patent Literature

Patent Literature 1: Japanese Patent Laid-Open No. H7-287124

### SUMMARY OF THE INVENTION

### Technical Problem

The device disclosed in Patent Literature 1 needs to prepare a container accommodating a washing solvent made of alcohol or the like. This causes a user to convey each of the device and the separate alcohol container, increasing his or her baggage. Furthermore, since alcohol is a dangerous substance, it is difficult for the user to carry alcohol.

The present invention has been. made in view of the above and has an object to provide a cleaning body and a cleaning device that are capable of reducing a burden of conveyance by a user to enhance safety and suitably exhibiting cleaning capability.

### Means for Solving the Problem

To solve the problem, a cleaning body of the present invention includes a cloth-like body unit and a washing liquid enclosure provided on a surface of the body unit or inside the body unit and enclosing a washing liquid including alcohol.

According to this configuration, the washing liquid including alcohol is, as the washing liquid enclosure, integrally provided on the cloth-like body unit, enabling to prevent the alcohol from evaporating and eliminate a need for separately conveying alcohol. Furthermore, a user is prevented from touching alcohol during, for example, conveyance, enabling to enhance safety. Furthermore, during cleaning, the washing liquid including alcohol leaves the washing liquid enclosure and soaks into the body unit, enabling to suitably exhibit cleaning capability.

Furthermore, a cleaning device of the present invention is a cleaning device including the cleaning body and includes a pair of reels between which the cleaning body having an elongated shape is disposed and a head. that curves the cleaning body between the pair of reels.

According to this configuration, the head curves the cleaning body and presses the cleaning body against an object to thereby allow the washing liquid including alcohol to soak into the body unit, enabling to prevent alcohol from adhering to the user and more suitably exhibit cleaning capability.

### Effects of the Invention

The present invention can reduce a burden of conveyance by the user to enhance safety, and exhibit a suitable cleaning capability.

### BRIEF DESCRIPTION OF DRAWINGS

FIG. 1 is a cross-sectional view schematically showing a cleaning device according to an embodiment of the present invention.

FIG. 2 is a perspective view schematically showing a head and a cleaning body that are included in the cleaning device according to the embodiment of the present invention.

FIG. 3 is a side view schematically showing a use example of the cleaning device according to the embodiment of the present invention.

FIG. 4 is a side view schematically showing another example of the cleaning device according to the embodiment of the present invention.

### DESCRIPTION OF EMBODIMENTS

A cleaning device according to an embodiment of the present invention will be explained in detail in reference to the drawings as appropriate.

<Cleaning Device>

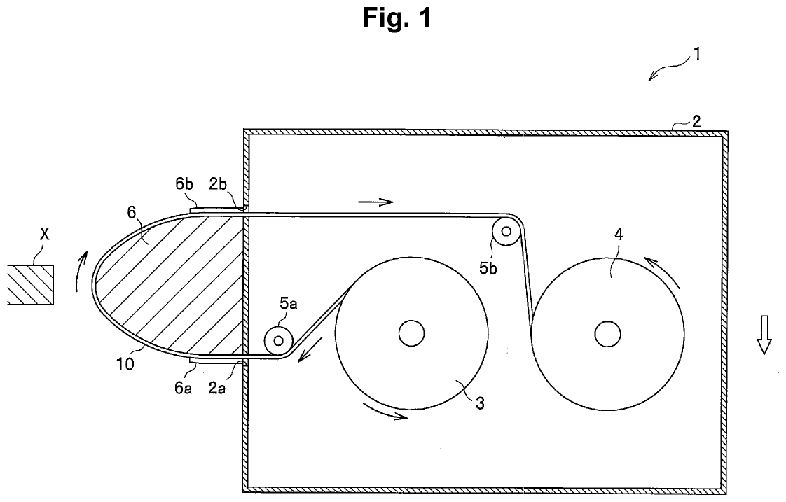

As shown in. FIG. 1, a cleaning device 1 according to the embodiment of the present invention is a device for cleaning a surface of an object X (for example, an end surface of an optical fiber). The cleaning device 1 includes a housing 2, a pair of reels 3 and 4, a plurality of guide units 5a and 5b, a head 6, and a cleaning body 10 having an elongated shape (in the form of a tape).

<<Housing>>

The housing 2 accommodates the reels 3 and 4 and the plurality of guide units 5a and 5b. A side wall portion of the housing 2 parallel to rotation axes of the reels 3 and 4 has opening portions 2a and 2b.

<<Reel (Unused Side)>>

An outer peripheral surface of the reel 3 is wound. with one end side (unused side) of the cleaning body 10. The reel 3 provided in the housing 2 so as to be rotatable in a direction in which the cleaning body 10 is pulled out from the reel 3.

<<Reel (Used Side)>>

An outer peripheral surface of the reel 4 is wound with the other end side (used side) of the cleaning body 10. The reel 4 is provided in the housing 2 so as to be rotatable in a direction in which the cleaning body 10 is wound around the reel 4.

<<Guide Unit>>

The plurality of guide units 5a and 5b is for changing the traveling direction of the cleaning body 10 abutting against outer peripheral surfaces of the guide units 5a and 5b. The guide unit 5a is a columnar body provided in the housing 2 so as to guide the cleaning body 10 pulled out from the reel 3, in a direction. toward the opening portion 2a. The guide unit 5b is a columnar body or cylindrical body provided in the housing 2 so as to guide the cleaning body 10 introduced. from the opening portion 2b into the housing 2, in a direction toward the reel 4. The guide units 5a and 5b may be rollers rotatable in a direction of causing the cleaning body 10 to travel.

<<Head>>

The head 6 is a convex portion provided between the opening portions 2a and 2b in the side wall portion of the housing 2. An end surface of the head 6 is provided. with the cleaning body 10 so as to be movable in the longitudinal direction. That is, the head 6 curves the cleaning body 10 between the pair of reels 3 and 4. The vicinity of the opening portion 2a of the head 6 has a pair of wall units 6a vertically disposed from both end portions of the end surface of the head 6 in the width direction. The vicinity of the opening portion 2b of the head. 6 has a pair of wall units 6b vertically disposed from both end portions of the end surface of the head 6 in the width direction. These wall units 6a and 6b prevent the cleaning body 10 from separating .from the end surface of the head 6.

<<Cleaning Body>>

The cleaning body 10 is an elongated member disposed. between the reels 3 and 4. The cleaning body 10 pulled out from the reel 3 is led outside the housing 2 from the opening portion 2a via the guide unit 5a. The cleaning body 10 exposed outside the housing 2 curves along the end surface of the head 6 and is introduced from the opening portion 2b into the housing 2 to be wound around the reel 4 via the guide unit 5b.

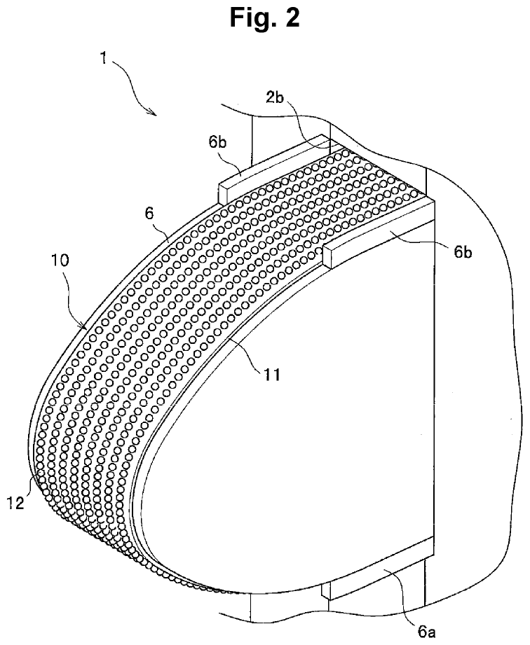

As shown in FIG. 2, the cleaning body 10 includes a body unit 11 having an elongated shape, and a plurality of washing liquid. enclosures 12.

<<Body Unit>>

The body unit 11 is a cloth-like member in the form of a felt having flexibility.

<<Washing Liquid Enclosure>>

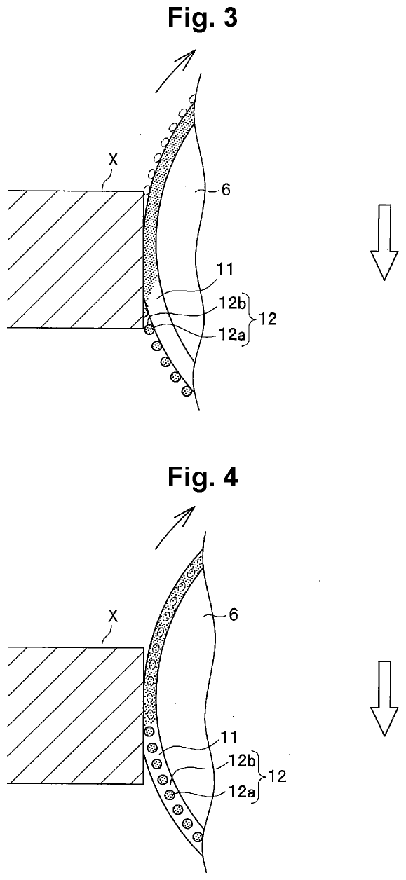

The washing liquid enclosure 12 encloses in a capsule 12b a washing liquid 12a including alcohol (see FIG. 3). As the washing liquid enclosure 12, microencapsulated alcohol can be suitably used, and in this case, a film formed of a soluble film is used as the capsule 12b. The washing liquid enclosure 12 is provided on a surface of the body unit 11 or inside the body unit 11. When the washing liquid enclosure 12 is provided on the surface of the body unit 11, a method such as adhesion is suitably used.

<Use Example>

As shown in FIG. 3, a user presses the cleaning body 10 exposed from the housing 2 against the object X in a state of holding the housing 2 of the cleaning device 1. Subsequently, the user moves the cleaning device 1 in a direction from the opening portion 2b to the opening portion 2a. The cleaning body 10 is thereby pulled out from the reel 3, passes over the head 6, and moves in a direction of being wound around the reel 4.

Here, at a portion where the cleaning body 10 is pressed against the object X, the capsule 12b of the washing liquid enclosure 12 ruptures by being sandwiched between the head 6 and the object X, and the washing liquid 12a in the washing liquid enclosure 12 soaks into the body unit 11 of the cleaning body 10. The cleaning body 10 soaked with the washing liquid 12a moves from the reel 3 side to the reel 4 side and thereby cleans the surface of the object X.

In the present embodiment, the washing liquid enclosure 12 is provided on the surface of the body unit 11 of the cleaning body 10 on the side abutting against the object X and, at portions wound around the reels 3 and 4, on the radially inner side. This configuration allows the washing liquid 12a to soak into the object. X side of the body unit 11 of the cleaning body 10, enabling to suitably achieve cleaning capability. Furthermore, the washing liquid enclosure 12 can be protected. at the portion wound. around the reel 3, and at the portion wound around the reel 4, the ruptured capsule 12b can be prevented from separating from the body unit 11.

AS shown in FIG. 4, the washing liquid enclosure 12 may be configured to be provided inside the body unit 11 of the cleaning body 10. Furthermore, although not shown in the drawings, when the washing liquid enclosure 12 is attached to the surface of the body unit 11 by means of an adhesive which affects cleaning capability of the body unit 11 (for example, a case where the adhesive is provided on the entire surface of the body unit 11), the washing liquid enclosure 12 may be configured to be provided on the opposite side to the object X, that is, on a surface abutting against the head 6 of the body unit 11. Even in this case, the washing liquid enclosure 12 can be configured to be provided on the radially inner side at the portions wound around the reels 3 and 4.

In the cleaning body 10 according to the embodiment of the present invention, the washing liquid 12a including alcohol is, as the washing liquid enclosure 12, provided on the cloth-like body unit 11, enabling to prevent the alcohol from evaporating and eliminate a need for separately conveying alcohol. Furthermore, the cleaning body 10 prevents the user from touching alcohol during, for example, conveyance, enabling to enhance safety. Furthermore, in the cleaning body 10, during cleaning, the washing liquid 12a including alcohol leaves the washing liquid enclosure 12 and soaks into the body unit 11, enabling to suitably exhibit cleaning capability.

Furthermore, in the cleaning device 1 according to the embodiment of the present invention, the head 6 curves the cleaning body and presses the cleaning body against the object to thereby allow the washing liquid 12a including alcohol to soak into the body unit 11, enabling to prevent alcohol from adhering to the user and more suitably exhibit cleaning capability.

Although the embodiment of the present. invention is explained above, the present invention is not limited to the above-described. embodiment and may be appropriately modified without departing from the gist of the present invention. For example, the body unit 11 of the cleaning body 10 is not limited to a cloth-like member in the form of a felt and may be any one into which the washing liquid 12a soaks to be capable of cleaning the surface of the object X. Furthermore, the washing liquid 12a may be, for example, any of various alcohols or may be a liquid having another washing capability. Furthermore, the cleaning body 10 is not limited. to a case of being applied to the cleaning device 1 and, as a push-type cleaner or the like, may be applied to a use method in which the cleaning body 10 alone cleans the surface of the object X. Furthermore, the structure of the cleaning device 1 is not limited to the above-described one and may be configured to include, for example, a spring that assists rotation of each of the reels 3 and 4. Furthermore, the object X to be cleaned is not limited to an optical fiber (an end surface thereof) and may be a liquid crystal screen, a mirror surface, or the like.

### REFERENCE SIGNS LIST

1 Cleaning device

2 Housing

3, 4 Reel

6 Head

10 Cleaning body

11 Body unit

12 Washing liquid enclosure

1. A cleaning body comprising:
a cloth-like body unit; and
a washing liquid enclosure provided on a surface of the body unit or inside the body unit and enclosing a washing liquid including alcohol.

2. A cleaning device comprising the cleaning body according to claim 1, comprising:
a pair of reels between which the cleaning body having an elongated shape is disposed; and
a head configured to curve the cleaning body between the pair of reels.
